(19) United States
(12) Patent Application Publication
(10) Pub. No.: US 2012/0245757 A1
(43) Pub. Date: Sep. 27, 2012

(54) Vehicle Data Recording Device

(75) Inventors: Ulf BARTHOLOMÄUS, St. Georgen (DE); Gerhard Rombach, Triberg (DE); Torsten Wahler, Bad Durrheim (DE)

(73) Assignee: Continental Automotive GmbH, Hannover (DE)

(21) Appl. No.: 13/429,009

(22) Filed: Mar. 23, 2012

(30) Foreign Application Priority Data
Mar. 24, 2011 (DE) 10 2011 014 978.3

(51) Int. Cl. G06F 17/00

(52) U.S. Cl. 701/1

(57) ABSTRACT

A vehicle data recording device including a vehicle data recording unit which has a housing, a data memory arranged outside the housing, and a unit interface with a connection for the data memory is provided in an outer wall of the housing. The data memory is connected to the unit interface by a connecting cable. To ensure not only that the data memory is reliably arranged in the vehicle data recording device but also that the data memory can be easily removed from the device, the housing has, on a housing outer side, a mount that detachably supports the data memory.

### BACKGROUND OF THE INVENTION

1. Field of the Invention

The invention relates to a vehicle data recording device including a vehicle data recording unit which has a housing, a data memory arranged outside the housing, and a unit interface with a connection of the data memory in an outer wall of the housing, wherein the data memory is connected to the unit interface by a connecting cable.

2. Description of the Related Art

EP 2 037 420 A2 discloses a vehicle data recording device having a vehicle data recording unit embodied as a digital tachograph. An electric connecting plug arranged at one end of a cable is connected to a plug socket provided on a front side of the tachograph having various operator control elements, specifically a screen, a card insertion slot and pushbutton keys. The other end of the cable is a loose free end which has a plug for connecting to a transmission control unit. In addition to other elements, the transmission control unit can also have a memory. In order to avoid overlapping of the operator control elements arranged on the front side of the tachograph, the cable is attached to the front side by two branches of a sheath covering the cable.

### SUMMARY OF THE INVENTION

An object of the invention is to provide a vehicle data recording device of the type mentioned at the beginning having a data memory that is not only arranged securely and reliably in the vehicle data recording device but can also be easily removed from the device.

According to one embodiment of the invention with a vehicle data recording device includes a housing that has, on a housing outer side, a mount which detachably supports the data memory.

The vehicle data recording device according to one embodiment the invention is provided to be arranged and used in a motor vehicle, in particular in a utility motor vehicle. The vehicle data recording unit may be, in particular, a tachograph or a recording unit in a motor vehicle, known as an on-board recorder. The vehicle data recording unit may, for example, also comprise the functions of a toll payment unit. Motor vehicles, in particular also utility motor vehicles, and units arranged therein are regularly subjected to oscillations, in particular in the form of vibrations, during operation of the motor vehicles. For this reason, in the invention it is a particular advantage that the data memory is reliably and securely and fixedly supported with the aid of the mount. The data memory is securely held in the mount even when there are severe decelerations such as can occur when the motor vehicle is braked sharply. The data memory can be used, for example, to protect data recorded by the vehicle data recording unit. It is particularly advantageous if the data memory not only can be detached from the mount to connect it more easily to another unit in order to pass on data, but also if the data memory can be additionally disconnected from the connecting cable. If the data memory is transportable data memory, it can easily be taken from the motor vehicle by a user of the vehicle data recording unit, to securely protect the data present on the data memory or to transfer this data to a fixed computer. A standardized interface that connects the connecting cable to the data memory is preferably provided between the data memory and the connecting cable. In order to permit the data memory to be connected freely to units other than the vehicle data recording unit, to fixed computers, the standardized interface can be a USB interface. The data memory is preferably what is referred to as a USB memory stick. The outer wall of the housing of the vehicle data recording unit in which the unit interface is provided for connecting the data memory is preferably a front side of the housing facing a user of the vehicle data recording device. The connecting cable is preferably connected to the unit interface by a plug-type connection. The connecting cable can be connected to the data memory in a basically nondetachable fashion, that is to say in such a way that it cannot be detached without being damaged; however, the data memory is preferably connected to the connection cable by a plug-type connection, which plug-type connection preferably has the above-mentioned standardized interface. In the invention, mechanical decoupling of the unit interface and the data memory by virtue of the connecting cable arranged between them is of particular advantage. Oscillations of the data memory therefore do not lead to mechanical loading of the unit interface.

In one embodiment, the data memory is screwed to the mount. However, to permit the data memory to be removed particularly easily from the vehicle data recording device it is particularly advantageous if, according to one development of the invention, the mount has at least one clamping element that supports the data memory in a clamping fashion.

The housing of the vehicle data recording unit may be particularly simple in design and cost-effective to manufacture if, according to one embodiment of the invention, the clamping element has a spring clip that applies a pressure force to the data memory. The pressure force is a clamping force for the data memory. The spring clip may be composed of metal or of a plastic.

According to one embodiment of the invention, the clamping element is embodied in a U shape, and the data memory is arranged between limbs of the U. The mount therefore has a particularly high level of functional reliability accompanied by a simple structural configuration. The limbs of the U clamp the data memory advantageously between them.

The design of the mount can also be further simplified if, according to one embodiment of the invention, the spring clip has a first limb of the U, and if the second limb of the U is formed by the housing outer side.

In particular, in the case of a vehicle data recording device in a motor vehicle used on uneven terrain, for example a construction motor vehicle or an off-road truck, or for example a vehicle data recording device regularly subjected to particularly strong vibration loading, it is advantageous if, according to one embodiment of the invention, the mount has a securing element that prevents unintentional detachment of the data memory. The securing element may have, for example, a clamping bracket or a rubber clip. The securing element can also have, for example, what is referred to as a touch and close fastener to permit particularly easy opening and closing of the securing element.

The protection of the data memory is advantageously improved even in the case of a strong vibration or oscillation loading of the vehicle data recording device according to the invention if, according to one embodiment of the invention, the mount has a damping element that supports the data memory with respect to the housing. The damping element may be, for example, an upholstered element. Said element may be embodied in one part or multiple parts. The damping element may be arranged, for example, on the inside, facing the data memory, of one or both limbs of the U of a clamping element which is embodied in a U shape; alternatively or additionally, the damping element can also be arranged on the inside, facing the data memory, of the depression in the U which is arranged between the two limbs.

The housing of the vehicle data recording unit has, on a front side of the housing, the mount that supports the data memory. However, the accessibility of the vehicle data recording unit and, in particular, of operator control elements on the front side of the vehicle data recording unit is not restricted if, according to one embodiment of the invention, the housing has a front side facing a user and if the mount is arranged on a housing outer side connected to the front side at an angle. The housing is preferably embodied at least essentially in the form of a right parallelepiped. The housing outer side on which the mount is arranged is preferably connected to the front side at at least essentially a right angle and is located next to and behind the front side with respect to the user.

According to one embodiment of the invention, the vehicle data recording unit is an individual unit. As a result, the housing can easily have the mount for the data memory at a particularly easily accessible location. Individual device means that the vehicle data recording unit is not an installation unit for installation in a dashboard or a cockpit of the motor vehicle; as a result, an installation frame for such a mounting of the vehicle data recording unit is not necessary either. In contrast to an installation unit, the vehicle data recording unit as an individual unit developed according to the invention is preferably an attachment unit or, if appropriate, a built-on unit or built-in unit. As an attachment unit, the vehicle data recording unit can be fitted onto a dashboard of the motor vehicle and mounted there, as a built-in unit it can be mounted in such a way that it is suspended from an inner roof lining of a driver's cab or of a passenger compartment of the motor vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is illustrated in the drawings and will be described in more detail below.

FIG. 1 is a vehicle data recording device in a front view; and

FIG. 2 is the vehicle data recording device from FIG. 1 in a side view.

Corresponding elements are provided with respectively identical reference symbols in all the figures.

### DETAILED DESCRIPTION OF THE PRESENTLY PREFERRED EMBODIMENTS

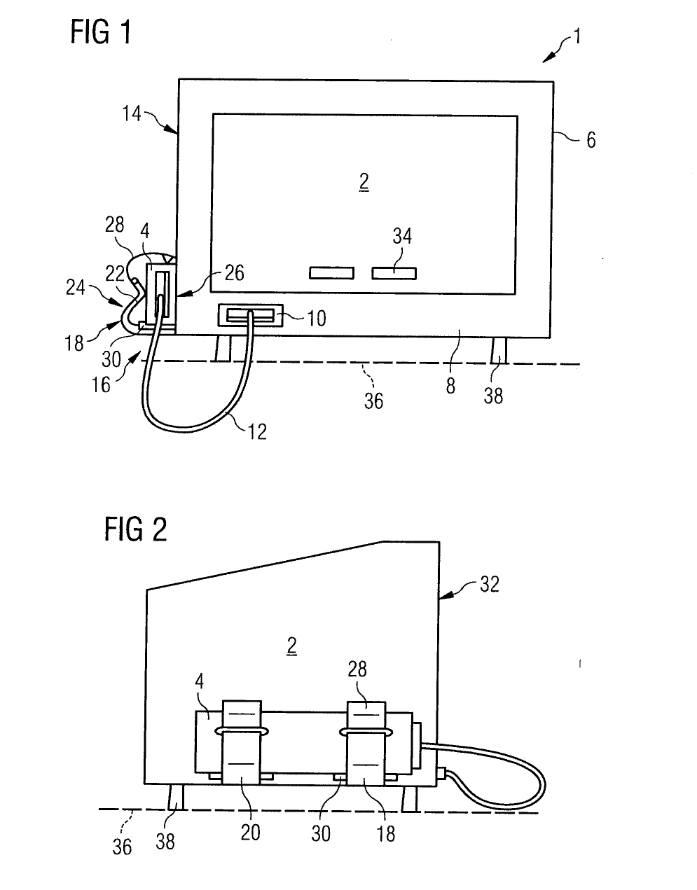

FIG. 1 shows a vehicle data recording device 1 with a vehicle data recording unit 2 and a data memory 4 embodied as a USB memory stick. The data memory 4 is arranged outside a housing 6 of the vehicle data recording unit 2. In a front-side outer wall 8 of the housing 6, a unit interface 10 with a connection for, the data memory 4 is provided. The data memory 4 is connected to the unit interface 10 by a connecting cable 12. The housing 6 has a mount 16 which detachably supports the data memory 4 on a housing outer side 14.

In one embodiment, the mount 16 has two clamping elements 18, 20 which support the data memory 4 in a clamping fashion (see FIG. 2). The clamping elements 18, 20 are arranged one behind the other in a view from the front (see FIG. 1) and are of substantially identical design; their design is explained briefly below based on the clamping element 18 at the front in the front view. The clamping element 18 has a spring clip 22 which applies a pressure force to the data memory 4. In addition, FIG. 1 shows the clamping element 18 in a U shape, and the data memory 4 is arranged between the limbs 24, 26 of the U. In this context, the spring clip 22 has a first limb 24, and the second limb 26 of the U is formed by the housing outer side 14 on which the mount 16 is arranged.

Furthermore, the mount 16 has a securing element 28 embodied as a clamping bracket in one embodiment, which prevents unintentional detachment of the data memory 4. Furthermore, the mount 16 has a damping element 30 that supports the data memory 4 with respect to the housing 6.

From FIGS. 1 and 2 it is apparent that the housing 6 is embodied approximately in the form of a right parallelepiped and has a front side 32 which faces a user and has operator control elements 34. In this example, the front side 32, is the outer wall 8 in which the unit interface 10 for connecting the data memory 4 is arranged. The housing outer side 14 on which the mount 16 is arranged is connected to the front side 32 at an angle; in this exemplary embodiment, the angle is 90°, and the housing outer side 14 with the mount 16 is a side face of the approximately right-parallelepiped-shaped housing 6.

Furthermore, FIGS. 1 and 2 show, by dashed lines, an upper side 36 of a dashboard of a motor vehicle on which dashboard the vehicle data recording unit 2 is attached by feet 38 arranged on the housing 6. The vehicle data recording unit 2 is an individual unit embodied as an attachment unit here.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vehicle data recording device, comprising:
a vehicle data recording unit having a housing;
a data memory arranged outside the housing;
an interface for the data memory provided in an outer wall of the housing;
a connecting cable that connects the data memory to the interface; and
a mount arranged on a housing outer side that detachably supports the data memory.

2. The vehicle data recording device as claimed in claim 1, wherein the mount has at least one clamping element that supports the data memory in a clamping fashion.

3. The vehicle data recording device as claimed in claim 2, wherein the clamping element comprises a spring clip that applies a pressure force to the data memory.

4. The vehicle data recording device as claimed in claim 2, wherein the clamping element is configured in a U-shape, the data memory is arranged between limbs of the U-shape.

5. The vehicle data recording device as claimed in claim 3, wherein the spring clip has a first limb of a U-shape and a second limb of the U-shape is formed by the housing outer side.

6. The vehicle data recording device as claimed in claim 2, wherein the mount comprises a securing element that substantially prevents unintentional detachment of the data memory.

7. The vehicle data recording device as claimed in claim 1, wherein the mount comprises a damping element that supports the data memory with respect to the housing.

8. The vehicle data recording device as claimed in claim 1, wherein the housing has a front side facing a user, and the mount is arranged on the housing outer side that is connected to the front side at an angle.

9. The vehicle data recording device as claimed in claim 1, wherein the vehicle data recording unit is an individual unit.

10. The vehicle data recording device as claimed in claim 3, wherein the clamping element is configured in a U-shape, the data memory is arranged between limbs of the U-shape.

11. The vehicle data recording device as claimed in claim 10, wherein the spring clip has a first limb of the U-shape and the second limb of the U-shape is formed by the housing outer side.

12. The vehicle data recording device as claimed in claim 11, wherein the mount comprises a securing element that substantially prevents unintentional detachment of the data memory.
